(19) United States
(12) Patent Application Publication
(10) Pub. No.: US 2025/0373468 A1
(43) Pub. Date: Dec. 4, 2025

(54) CLIENTLESS VIRTUAL PRIVATE NETWORKING

(71) Applicant: AT&T Intellectual Property I, L.P., Atlanta, GA (US)

(72) Inventor: Richard Zaffino, Kirkland, WA (US)

(21) Appl. No.: 18/677,825

(22) Filed: May 29, 2024

(51) Int. Cl. H04L 12/46; H04L 9/40; H04L 47/24

(52) U.S. Cl. CPC H04L 12/4641; H04L 12/4633; H04L 47/24; H04L 63/0272; H04L 63/0281; H04L 63/029

(57) ABSTRACT

One example of a method performed by a processing system of a device in a communications service provider core network includes obtaining a characteristic of a first network traffic flow received from a user endpoint device that is connected to the communications service provider core network via an access network, determining whether the characteristic indicates a need to route the first network traffic flow over a virtual private network, creating an encrypted tunnel from the device to a virtual private network proxy, and routing the first network traffic flow to the virtual private network proxy via the encrypted tunnel.

The present disclosure relates generally to mobile communications networks, and relates more particularly to devices, non-transitory computer-readable media, and methods for providing clientless virtual private networking.

### BACKGROUND

A virtual private network (VPN) is a means of establishing a secure connection between a user endpoint device and a network using an insecure communication medium (e.g., the Internet). In mobile networking, a mobile user endpoint device (e.g., a mobile phone, a tablet computer, or the like) may include a VPN client that is responsible for establishing a virtual point-to-point connection to a network, using tunneling protocols. All traffic between the mobile user endpoint device and the network will then traverse this point-to-point connection.

### SUMMARY

The present disclosure broadly discloses methods, computer-readable media, and systems for providing clientless virtual private networking. In one example, a method performed by a processing system of a device in a communications service provider core network includes obtaining a characteristic of a first network traffic flow received from a user endpoint device that is connected to the communications service provider core network via an access network, determining whether the characteristic indicates a need to route the first network traffic flow over a virtual private network, creating an encrypted tunnel from the device to a virtual private network proxy, and routing the first network traffic flow to the virtual private network proxy via the encrypted tunnel.

In another example, a non-transitory computer-readable medium may store instructions which, when executed by a processing system of a device in a communications service provider core network, cause the processing system to perform operations. The operations may include obtaining a characteristic of a first network traffic flow received from a user endpoint device that is connected to the communications service provider core network via an access network, determining whether the characteristic indicates a need to route the first network traffic flow over a virtual private network, creating an encrypted tunnel from the device to a virtual private network proxy, and routing the first network traffic flow to the virtual private network proxy via the encrypted tunnel.

In another example, a device in a communications service provider core network may include a processing system including at least one processor and a non-transitory computer-readable medium storing instructions which, when executed by the processing system, cause the processing system to perform operations. The operations may include obtaining a characteristic of a first network traffic flow received from a user endpoint device that is connected to the communications service provider core network via an access network, determining whether the characteristic indicates a need to route the first network traffic flow over a virtual private network, creating an encrypted tunnel from the device to a virtual private network proxy, and routing the first network traffic flow to the virtual private network proxy via the encrypted tunnel.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for providing clientless virtual private networking may operate;

FIG. 2 illustrates a flowchart of an example method for providing clientless virtual private networking, in accordance with the present disclosure;

FIG. 3 illustrates a flowchart of an example method for providing clientless virtual private networking, in accordance with the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for providing clientless virtual private networking. As discussed above, a virtual private network (VPN) is a means of establishing a secure connection between a user endpoint device and a network using an insecure communication medium (e.g., the Internet). In mobile networking, a mobile user endpoint device (e.g., a mobile phone, a tablet computer, a smart pair of eye glasses or goggles, or the like) may include a VPN client that is responsible for establishing a virtual point-to-point connection to a network, using tunneling protocols. All traffic between the mobile user endpoint device and the network will then traverse this point-to-point connection.

Traffic that is carried over the point-to-point connection is encrypted and not visible to the network infrastructure as the traffic traverses the tunnel. This makes VPNs very attractive solutions to customers who are concerned about privacy. However, the lack of visibility into the tunneled traffic also creates challenges for mobile network service providers whose services may rely, in at least some part, on the ability to identify certain characteristics of the traffic. For instance, traffic containing certain types of data (e.g., streaming video files, sensor readings from monitored locations, or the like) or traffic traveling to or from certain endpoints (e.g., mobile devices that subscribe to services that guarantee prioritized handling), may require specific routing and/or steering over the mobile communications network. The inability to detect characteristics of tunneled traffic may therefore make it difficult for a mobile network service provider to optimize handling of the tunneled traffic. Thus, customer experience may suffer from sub-optimal performance.

Moreover, VPN treatment tends to be an all-or-nothing proposition. That is, if the VPN client on a user endpoint device has enabled a VPN, then all traffic traveling between the user endpoint device and the other tunnel endpoint generally travels over the VPN, without exception. At best, some VPN clients may allow traffic traveling over specific types of networks (e.g., cellular, WiFi, or the like) to bypass the VPN, or may allow specific applications to bypass the VPN.

Examples of the present disclosure provide virtual private networking functionality via a network-side function, as opposed to the conventional client-side function. This arrangement allows traffic traveling between two endpoints between which a VPN may be enabled to be considered for VPN treatment on a case-by-case basis, as opposed to being automatically carried over the VPN. In one example, a discriminator function at the network edge (e.g., in an edge router) may determine, based on characteristics of network traffic received at the discriminator function, whether the network traffic should be routed via an encrypted tunnel to a VPN proxy (e.g., a VPN provider's point of presence) or should bypass the encrypted tunnel. The endpoints of the encrypted tunnel are the discriminator function (or a device of which the discriminator function is a part, such as an edge router) and the VPN proxy (i.e., the user endpoint device at which the network traffic originates is not an endpoint of the encrypted tunnel). Thus, the discriminator function acts as a relay point for VPN traffic. In further cases, the discriminator function may also extend the tunnel back through a network interface to a user endpoint device.

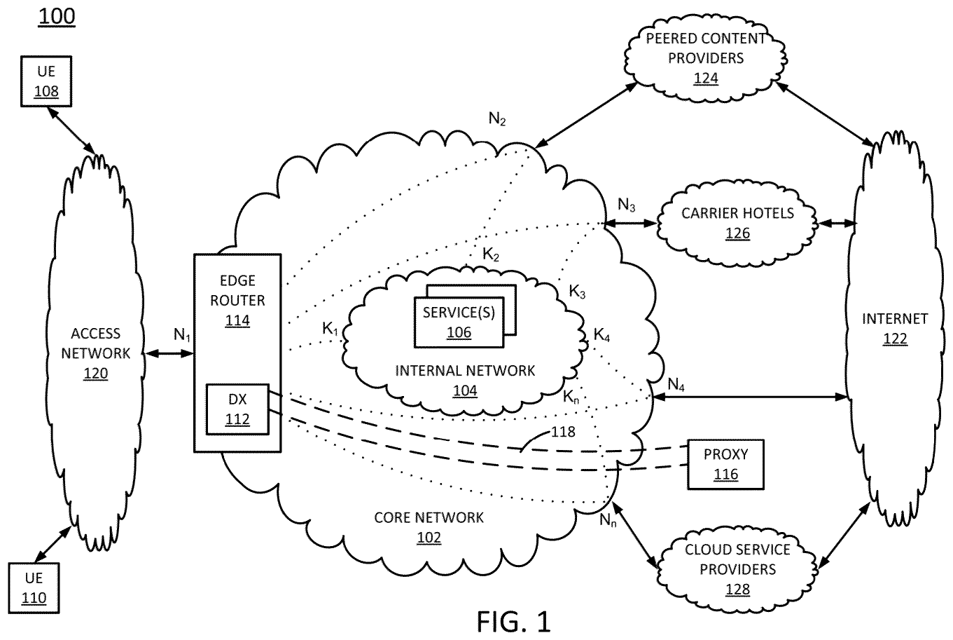

Within the context of the present disclosure, “clientless” virtual private network is understood to refer to the fact that a flow of network traffic from a user endpoint device (or more specifically, from an application executing on the user endpoint device) may be selectively routed via a VPN even though the user endpoint device may not include a VPN client. These and other aspects of the present disclosure are discussed in greater detail below in connection with the examples of FIGS. 1-4.

To further aid in understanding the present disclosure, FIG. 1 illustrates an example system 100 in which examples of the present disclosure for providing clientless virtual private networking may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, 6G and any future generation networks, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access network 120, and with the Internet 122. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include a service provider internal network 104, a plurality of edge routers, such as edge router 114, and a plurality of interfaces N₁-Nₙ (hereinafter individually referred to as a “core network interface N” or collectively referred to as “core network interfaces N”) via which the core network 102 may communicate with other networks (e.g., access network 120, specialized networks 124, 126, and 128, Internet 122, and the like). In one example, the core network interface N₁ that connects the access network 120 to the core network 102 may have connections (shown as dotted lines in FIG. 1) to all of the remaining core network interfaces N₂-Nₙ. For ease of illustration, various additional elements of the core network 102 are omitted from FIG. 1.

The internal service provider network 104 may include infrastructure for providing various internal services 106 that may affect routing of network traffic through the core network 102, such as domain name system (DNS) services, parental control services, secure browsing/cyber security services, video policy services, and/or other services. The internal service provider network 104 may further include a plurality of interfaces K₁-Kₙ (hereinafter individually referred to as an “internal network interface K” or collectively referred to as “internal network interfaces K”) via which the internal service provider network 104 may communicate with other networks (e.g., access network 120, specialized networks 124, 126, and 128, Internet 122, and the like) via the core network interfaces N. This allows the internal services 106 to access the access network 120, specialized networks 124, 126, and 128, and Internet 122.

In one example, the access network 120 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network or the like), a cellular access network, a 3^{rd} party network, or the like. For example, the operator of the core network 102 may provide a cable television service, an IPTV service, a media streaming service, or any other types of communication services to subscribers via access network 120.

In one example, the core network 102 may be operated by a communication network service provider (e.g., an Internet service provider, or a service provider who provides Internet services in addition to other communication services). The core network 102 and the access network 120 may be operated by different service providers, the same service provider or a combination thereof, or the access network 120 may be operated by an entity having core businesses that are not related to communications services, e.g., corporate, governmental, or educational institution LANs, and the like.

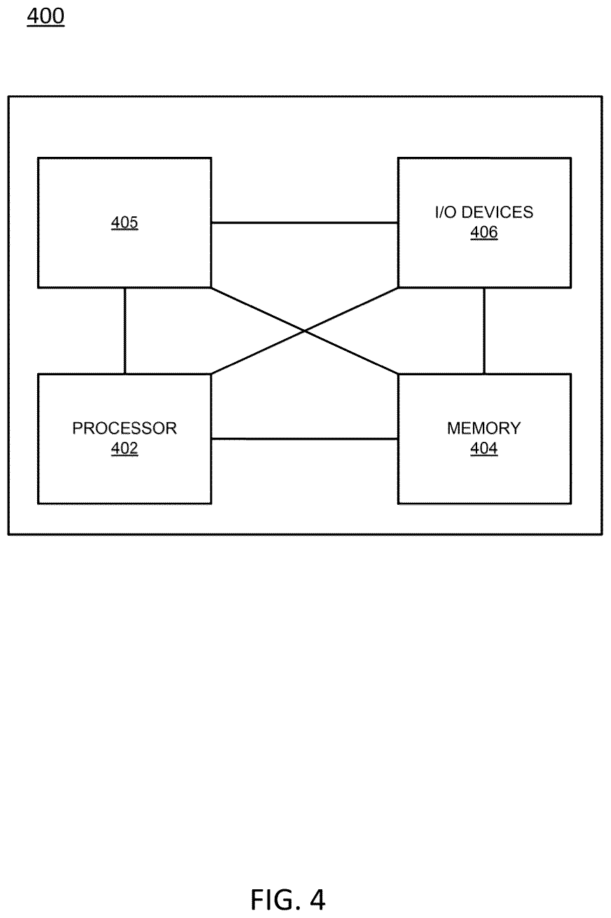

In one example, the access network 120 may be in communication with one or more user endpoint devices (UEs) 108 and 110. The access network 120 may transmit and receive communications between the user endpoint devices 108 and 110, between the user endpoint devices 108 and 110, internal network 104, the Internet 122, specialized networks such as a peer content provider network 124 (e.g., including media streaming services, such as streaming video and audio services), a carrier hotel network 126 (e.g., including large-scale data centers), a cloud service provider network 128 (e.g., including cloud computing services), a VPN proxy 116, other components of the core network 102, devices reachable via the Internet in general, and so forth. In one example, each of the user endpoint devices 108 and 110 may comprise any single device or combination of devices that may comprise a user endpoint device, such as computing system 400 depicted in FIG. 4, and may be configured as described below. For example, the user endpoint devices 108 and 110 may each comprise a mobile device, a cellular smart phone, a gaming console, a set top box, a laptop computer, a tablet computer, a desktop computer, an autonomous vehicle, an extended reality (XR) device, an Internet of Things (IoT) device, an application server, a pair of smart eye glasses or goggles, a bank or cluster of such devices, and the like.

Each of the UEs 108 and 110 may have a plurality of applications executing thereon. These applications may include, for example, media streaming applications (e.g., streaming video or audio), gaming applications, Web browsing applications, banking applications, navigation applications, social media applications, and the like. Some of these applications may require treatment by one or more of the internal services 106. Other applications may require that the network traffic between the UE 108 or 110 and an endpoint (e.g., VPN proxy 116) be carried via VPN. In other words, although a plurality of different applications may execute simultaneously on the same UE 108 or 110, not all of those different applications will require that their associated network traffic be handled in the same manner.

For example, a non-VPN (but encrypted) connection from a UE 108 or 110 is made over the access network 120 to core network interface N1 and to subsequent networks or services 106 in the internal service provider network 104 (via the appropriate internal network interface K) or to connected networks (e.g., Internet 122, peered content provider network 124, carrier hotel network 126, cloud service provider network 128, or another network) via the appropriate core network interface N. In this case, the edge router 114 may not connect the access network 120 to the core network 102, or may not include the discriminator function (Dx) 112 (discussed in further detail below).

A typical VPN would establish an encrypted tunnel from the UE 108 or 110 to a VPN proxy (e.g., VPN proxy 116) that is connected to the core network 102. The encrypted tunnel would isolate all traffic from the service provider internal network 104. Thus, none of the internal services 106 would be available to the UE 108 or 110 unless: (a) the traffic left the VPN proxy 116 for the Internet 122 (in general, a connection does exist between the VPN proxy 116 and the Internet 122); (b) the traffic was able to re-enter the core network 102 (e.g., via one of the core network interfaces N₂-Nₙ); or (c) the internal services 106 were available to inbound traffic at the internal network interfaces K₂-Kₙ. With respect to (c), however, it is noted that many services like the internal services 106 are only available to inbound traffic at the internal network interface K₁ that connects the service provider internal network 104 to the access network 120/core network interface N₁.

Thus, core network interfaces N₂-N₅ and internal network interfaces K₂-K₅ to the specialized networks 124, 126, and 128 and to the Internet 122, as well the internal network interface K₁ to the access network 120, are not accessible to traffic that is routed through the encrypted tunnel (e.g., the traffic cannot “see” these interfaces N and K). Likewise, the service provider internal network 104 cannot route traffic that is routed through the encrypted tunnel to the internal network interface K₁ for application of internal services 106 (e.g., the service provider internal network 104 cannot “see” the traffic in the encrypted tunnel).

Examples of the present disclosure deploy a discriminator function (Dx) 112 that has access to all of the core network interfaces N₁-N₅ and to at least the internal network interface K₁ that connects the service provider internal network 104 to the access network 120. In one example, the discriminator function 112 may be deployed at the edge of the core network 102 (e.g., in edge router 114).

Thus, in one example, the discriminator function 112 is located so that the discriminator function 112 can see all inbound network traffic from the access network 120. In a further example, the discriminator function 112 may be configured to identify characteristics of the inbound network traffic and to select an appropriate set of interfaces (e.g., core network interface(s) N and/or internal network interface(s) K)) via which to route the inbound network traffic so that the necessary internal services 106 are applied.

In one example, when the discriminator function 112 determines that a particular flow of network traffic from a UE 108 or 110 (which may already have been encrypted) should be protected by a VPN, the discriminator function 112 may create a tunnel (e.g., tunnel 118) and route the flow of network traffic via the tunnel to the VPN proxy 116. For flows of network traffic that are determined by the discriminator function 112 to not need protection by a VPN, the discriminator function 112 may route these flows so that the flows bypass the tunnel 118. The determination as to whether a given flow of network traffic requires protection by a VPN may be based on traffic inspection, traffic identification, and/or traffic characterization by the discriminator function. The determination may also or alternatively be based on traffic identification and/or traffic characterization information provided by the UE 108 or 110. The determination may also or alternatively be based on information provided by the UE 108 or 110 that relates to the specific application from which the given flow of network traffic originated.

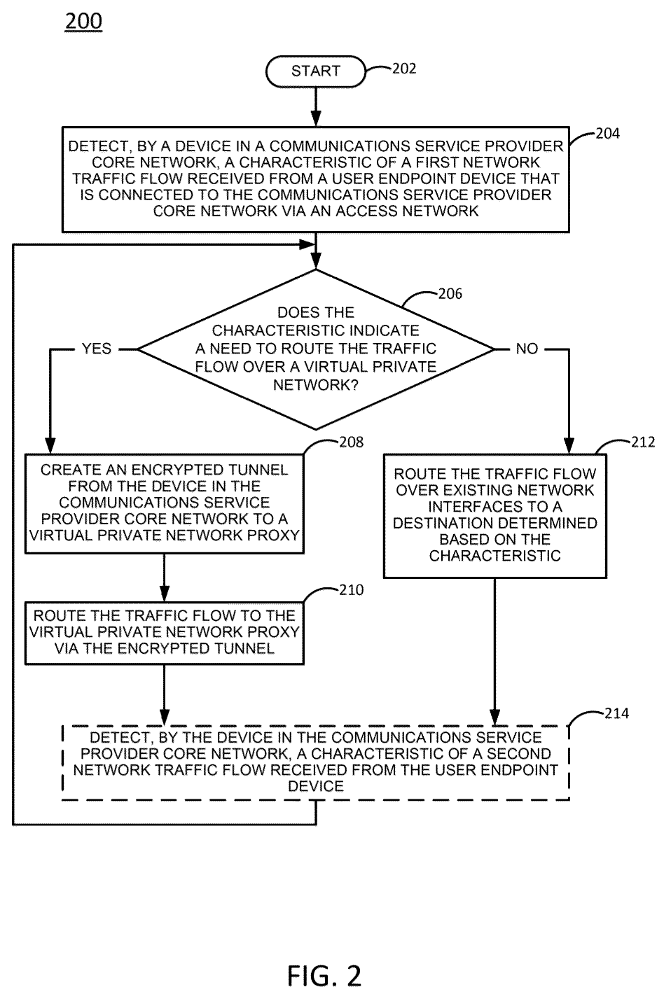

The discriminator function 112 itself does not require a VPN client, and in one example any tunnel 118 created by the discriminator function 112 will terminate at the discriminator function 112 rather than at the UE 108 or 110 (with the other endpoint of the tunnel 118 being the VPN proxy 116). However in other examples the discriminator function 112 may extend the tunnel 118 all the way to the UE 108 or 110. Further details of an example method for providing clientless virtual private networking by the discriminator function 112 is described in greater detail below in connection with FIG. 2.

The discriminator function 112 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access network 120, internal network 104, specialized networks 124-128, and/or Internet 122 may comprise a content distribution network (CDN) having ingest servers, edge servers, and the like. Similarly, although only one access network 120 is shown, in other examples, the access network 120 may comprise a plurality of different access networks that may interface with the core network 102 independently or in a chained manner. For example, UE devices 108 and 110 may communicate with the core network 102 via different access networks. Thus, these and other modifications are all contemplated within the scope of the present disclosure.

FIG. 2 illustrates a flowchart of an example method 200 for providing clientless virtual private networking, in accordance with the present disclosure. In one example, steps, functions and/or operations of the method 200 may be performed by a device as illustrated in FIG. 1, e.g., a discriminator function 112 of an edge router 114 in a communications service provider core network 102 (or any one or more components thereof). In another example, the steps, functions, or operations of method 200 may be performed by a computing device or system 400, and/or a processing system 402 as described in connection with FIG. 4 below. For instance, the computing device 400 may represent an edge router 114 or a discriminator function 112 in accordance with the present disclosure. For illustrative purposes, the method 200 is described in greater detail below in connection with an example performed by a processing system, such as processing system 402.

The method 200 begins in step 202. In step 204, the processing system may detect a characteristic of a first network traffic flow received from a user endpoint device that is connected to a communications service provider core network via an access network.

In one example, the user endpoint device may be a mobile user endpoint device, such as a cellular smart phone, a gaming console, a laptop computer, a tablet computer, an autonomous vehicle, an extended reality (XR) device, an Internet of Things (IoT) device, a pair of smart eye glasses or goggles, or the like. The user endpoint device may connect to a mobile access network (e.g., a radio access network) which connects to a core network interface of a core network operated by a communications network service provider. In one example, the processing system may be positioned at the core network interface via which the mobile access network connects to the core network.

In one example, at least one software application may be executing on the user endpoint device. In a further example, a plurality of different software applications may be simultaneously executing on the user endpoint device. For instance, the user endpoint device may simultaneously be executing a navigation application and a streaming music application. Each application that is executing on the user endpoint device may generate a flow of network traffic containing data to be exchanged with a device or service that is also connected to the core network.

The flow of network traffic may be characterized by one or more characteristics that are detectable by the processing system. These characteristics may influence whether the flow of network traffic requires handling by one or more specialized networks or services (e.g., DNS services, parental control services, secure browsing/cyber security services, video policy services, and/or other services). In one example, the characteristic that is detected may comprise a single characteristic or a combination of two or more characteristics. For instance, in one example, the characteristic may comprise at least one of: a source IP address of the flow of network traffic, a destination IP address of the flow of network traffic, a source port of the flow of network traffic, a destination port of the flow of network traffic, a nature of the data contained within the flow of network traffic (e.g., video data, audio data, gaming data, global positioning information, sensor feed, Web browsing history, business email, or the like), a subscription tier of a service to which a user of the user endpoint device is subscribed, a type of network to which the user endpoint device is connected, multipurpose Internet mail extensions (MIME) types, server name indication (SNI) used in transport layer security (TLS), traffic type (e.g., some traffic can be “fingerprinted” such that the traffic type can be inferred, perhaps using artificial intelligence), specific knowledge of the user endpoint device (e.g., a camera that always and only sends video data), a header or “preamble signal” sent by an application or operating system of the user endpoint device to specifically supply characteristics, the access point name (APN) or data network name (DNN) used by the user endpoint device to connect (which can indirectly convey traffic characteristics, such as a unique DNN for public safety or incident response), a slice ID (as in 5G slicing) or slice characteristics applied to a slice used for 5G access (which can indirectly convey traffic characteristics, such as a low latency slice), and/or other characteristics.

In one example, the characteristic of a first network traffic flow may be detected in any one or more of a number of ways. For instance, the characteristic may be detected using at least one of: traffic inspection, through a signal from the user endpoint device to the network, or based on subscription characteristics associated with the user endpoint device (e.g., always use VPN, use VPN conditionally based on time of day, location, or other criteria).

In step 206, the processing system may determine whether the characteristic indicates a need to route the first network traffic flow over a virtual private network. In one example, the characteristic may be indicative of a need to utilize a VPN to route the first network traffic flow. For instance, network traffic flows that are directed to certain destinations (e.g., banking applications, health monitoring applications, or the like), that contain certain types of data (e.g., video data, sensor feeds, global positioning system information, Web browsing history, business emails, financial transactions, medical records, or the like), that are associated with devices or applications that are subscribed to VPN services, or that traverse certain types of networks (e.g., public WiFi), may be more likely than other network traffic flows to require the privacy afforded by a VPN. If, however, the first network traffic flow exhibits no characteristics that indicate a need for routing over a VPN, then the first network traffic flow may not require routing over a VPN.

If the processing system determines in step 206 that the characteristic indicates a need to route the first network traffic flow over a virtual private network, then the method 200 may proceed to step 208. In step 208, the processing system may create an encrypted tunnel from a device of which the processing system is a part (e.g., a discriminator function of an edge router in the communications service provider core network) to a virtual private network proxy.

In one example, the processing system may utilize one or more tunneling protocols, such as IP in IP version 4 (IPv4)/IP version 6 (IPv6), general routing encapsulation (GRE), OpenVPN, secure socket tunneling protocol, Internet protocol security, Layer 2 tunneling protocol, and/or another protocol. The tunneling protocol(s) may be used to create the encrypted tunnel, or point-to-point connection. The endpoints of this encrypted tunnel may be the device of which the processing system is a part and the VPN proxy. Thus, the user endpoint device that originated the traffic is not an endpoint of the encrypted tunnel.

In step 210, the processing system may route the first network traffic flow to the virtual private network proxy via the encrypted tunnel. The first network traffic flow will therefore be inaccessible to any internal services of a service provider internal network. As discussed above, these internal services may include DNS services, parental control services, secure browsing/cyber security services, video policy services, and/or other services.

If, however, the processing system determines in step 206 that the characteristic does not indicates a need to route the first network traffic flow over a virtual private network, then the method 200 may proceed to step 212. In step 212, the processing system may route the first network traffic flow over existing network interfaces to a destination determined based on the characteristic.

In one example, the existing network interfaces may include core network interfaces and internal network interfaces of a service provider internal network. The destination to which the first network traffic flow may be routed in step 212 may include, for example, one or more internal services of a service provider internal network, the Internet, or specialized network of another entity with which the communications service provider has arrangements (e.g., a cloud service provider network, a carrier hotel network, a peered content provider network, or the like).

Once the first network traffic flow is routed appropriately (e.g., either over the encrypted tunnel in accordance with step 210 or not over the encrypted tunnel in accordance with step 212), the method 200 may proceed to optional step 214 (illustrated in phantom). In step 214, the processing system may detect a characteristic of a second network traffic flow received from the user endpoint device.

In one example, the second network traffic flow may comprise a traffic flow that is associated with a different application than the application with which the first network traffic flow is associated. Thus, the second network traffic flow may be characterized by a different set of characteristics than the first network traffic flow. As such, the second network traffic flow may or may not require routing over a VPN, and may or may not require the same routing as the first network traffic flow. Thus, the method 200 may return to step 206, and the processing system may proceed as described above to examine characteristics of the second network traffic flow and route the second network traffic flow appropriately. As such, the method 200 allows VPN services to be applied to different network traffic flows originating from the same user endpoint device on a case by case basis (e.g., some of the network traffic flows may be routed via the encrypted tunnel and some network traffic flows may not be routed via the encrypted tunnel).

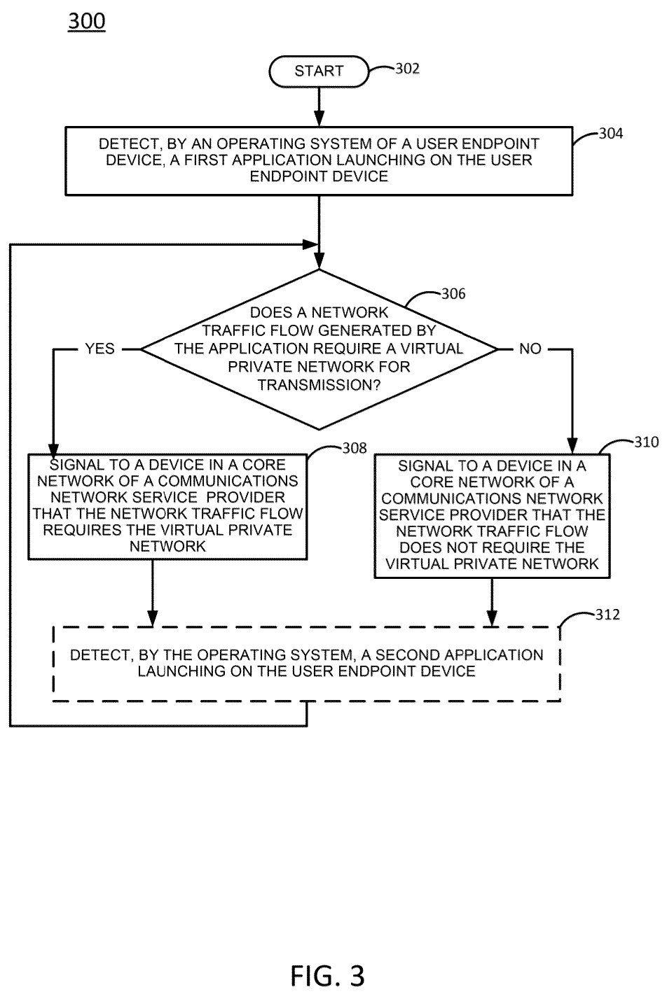

FIG. 3 illustrates a flowchart of an example method 300 for providing clientless virtual private networking, in accordance with the present disclosure. In one example, steps, functions and/or operations of the method 300 may be performed by a device as illustrated in FIG. 1, e.g., a UE 108 or 110 (or any one or more components thereof, such as an operating system). In another example, the steps, functions, or operations of method 300 may be performed by a computing device or system 400, and/or a processing system 402 as described in connection with FIG. 4 below. For instance, the computing device 400 may represent a user endpoint device in accordance with the present disclosure. For illustrative purposes, the method 300 is described in greater detail below in connection with an example performed by a processing system, such as processing system 402.

The method 300 begins in step 302. In step 304, the processing system may detect a first application launching on a user endpoint device of which the processing system is a part.

In one example, the user endpoint device may be a mobile user endpoint device, such as a cellular smart phone, a gaming console, a laptop computer, a tablet computer, an autonomous vehicle, an extended reality (XR) device, an Internet of Things (IoT) device, a pair of smart glasses or goggles, or the like. The user endpoint device may connect to a mobile access network (e.g., a radio access network) which connects to a core network interface of a core network operated by a communications network service provider. In one example, the core network interface via which the mobile access network connects to the core network may include a device (e.g., an edge router) that includes a discriminator function. The discriminator function may act as a network traffic relay point that examines network traffic flows on a case by case basis and routes the network traffic flows according to whether characteristics of the network traffic flows indicate a need for transmission over a VPN (or require treatment by one or more specialized services that cannot be applied if the network traffic flows are transmitted over a VPN).

In one example, at least one software application may be executing on the user endpoint device. In a further example, a plurality of different software applications may be simultaneously executing on the user endpoint device. For instance, the user endpoint device may simultaneously be executing a navigation application and a streaming music application. Each application that is executing on the user endpoint device may generate a flow of network traffic containing data to be exchanged with a device or service that is also connected to the core network.

In step 306, the processing system may determine whether a network traffic flow generated by the application requires a virtual private network for transmission. In one example, the processing system may be aware of a characteristic of the application and/or of the network traffic flow that indicates whether transmission via VPN is required. For instance, software applications typically have knowledge of what type of traffic (e.g., video, sensor feeds, financial or medical transactions, etc.) the software applications will handle and what destinations (e.g., services, uniform resource locators, IP address, etc.) the software applications will communicate with. The operating system of the user endpoint will typically know what applications are executing on the user endpoint device. Thus, using information that is knowable or detectable by the processing system, the processing system may be able to determine whether the network traffic flow should be steered toward an encrypted VPN tunnel or toward a different destination (e.g., an internal service of a service provider internal network, a specialized network, the Internet, etc.). As such, the processing system may be uniquely positioned to characterize the software applications executing on the user endpoint device and the network traffic generated by those software applications before the network traffic is sent to a VPN.

If the processing system concludes in step 306 that network traffic flow generated by the application requires a virtual private network for transmission, then the method 300 may proceed to step 308. In step 308, the processing system may signal to a device in a core network of a communications network service provider that the network traffic flow requires the virtual private network for transmission.

In one example, the device in the core network may comprise an edge router or other devices that include a discriminator function, as discussed above. In other examples, because the traffic discrimination can be performed on the user endpoint device side, the device in the core network may simply comprise a relay point with no traffic discrimination capability.

In one example, the processing system may set a flag in a header of a packet of the network traffic flow, where the flag (e.g., a “one” value) indicates to the device in the core network that the network traffic flow should be routed via the VPN.

If, however, the processing system concludes in step 306 that network traffic flow generated by the application does not require a virtual private network for transmission, then the method 300 may proceed to step 310. In step 310, the processing system may signal to the device in the core network of the communications network service provider that the network traffic flow does not require the virtual private network for transmission.

In one example, the signal that the network traffic flow does not require the VPN for transmission may include an indication of an alternate manner in which the network traffic flow is to be handled. For instance, the processing system may signal to the device in the core network that the network traffic flow should be routed to an internal service of a service provider internal network, to a specialized network, to the Internet, or the like. In one example, the processing system may set a flag (e.g., a “zero” value) in a header of a packet of the network traffic flow, where the flag indicates to the device in the core network that the network traffic flow should not be routed via the VPN (or should be routed to one of the alternate destinations).

Once the processing system has signaled to the device in the core network of the communications network service provider as to whether the virtual private network is required for transmission of the network traffic, the method 300 may proceed to optional step 312 (illustrated in phantom).

In step 312, the processing system may detect a second application launching on the user endpoint device. In one example, the second application may generate another network traffic flow, different from the first network traffic flow generated by the first application. Thus, the second network traffic flow may be characterized by a different set of characteristics than the first network traffic flow. As such, the second network traffic flow may or may not require routing over a VPN, and may or may not require the same routing as the first network traffic flow. Thus, the method 300 may return to step 306, and the processing system may proceed as described above to examine characteristics of the second network traffic flow and route the second network traffic flow appropriately. As such, the method 300 allows VPN services to be applied to different network traffic flows originating from the same user endpoint device on a case by case basis (e.g., some of the network traffic flows may be routed via the encrypted tunnel and some network traffic flows may not be routed via the encrypted tunnel).

It should be noted that the method 200 and the method 300 may be expanded to include additional steps or may be modified to include additional operations with respect to the steps outlined above. In addition, although not specifically specified, one or more steps, functions, or operations of the method 200 and the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 or FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for providing clientless virtual private networking, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 or the method 300 as discussed above is implemented in a distributed or parallel manner for a particular illustrative example, i.e., the steps of the above method 200 or the method 300 or the entire method 200 or method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200 or method 300. In one example, instructions and data for the present module or process 405 for providing clientless virtual private networking (e.g., a software program comprising computer-executable instructions) can be loaded into memory 404 and executed by hardware processor element 402 to implement the steps, functions, or operations as discussed above in connection with the illustrative method 200 or method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for providing clientless virtual private networking (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system of a device in a communications service provider core network, a characteristic of a first network traffic flow received from a user endpoint device that is connected to the communications service provider core network via an access network;
determining, by the processing system, that the characteristic indicates a need to route the first network traffic flow over a virtual private network;
creating, by the processing system, an encrypted tunnel from the device to a virtual private network proxy; and
routing, by the processing system, the first network traffic flow to the virtual private network proxy via the encrypted tunnel.

2. The method of claim 1, wherein the device is positioned at a core network interface via which the access network connects to the communications service provider core network.

3. The method of claim 2, wherein the device comprises an edge router than includes a discriminator function.

4. The method of claim 1, wherein the characteristic comprises at least one of: a source internet protocol address of the first network traffic flow, a destination internet protocol address of the first network traffic flow, a source port of the first network traffic flow, a destination port of the first network traffic flow, a nature of data contained within the first network traffic flow, a subscription tier of a service to which a user of the user endpoint device is subscribed, or a type of network to which the user endpoint device is connected.

5. The method of claim 1, wherein the encrypted tunnel is created without making the user endpoint device an endpoint of the encrypted tunnel.

6. The method of claim 1, further comprising:
detecting, by the processing system, a characteristic of a second network traffic flow received from the user endpoint device;
determining, by the processing system, that the characteristic of the second network traffic flow does not indicate a need to route the second network traffic flow over a virtual private network; and
routing, by the processing system, the second network traffic flow over one or more existing network interfaces to a destination determined based on the characteristic of the second network traffic flow.

7. The method of claim 6, wherein the one or more existing network interfaces comprise at least one of: a core network interface or an internal network interface of a service provider internal network within the communications service provider core network.

8. The method of claim 7, wherein the service provider internal network comprises a plurality of internal services.

9. The method of claim 8, wherein the characteristic of the second network traffic flow indicates that the second network traffic flow requires handling by at least one internal service of the plurality of internal services.

10. The method of claim 9, wherein the destination is the at least one internal service.

11. The method of claim 10, wherein the internal network interface connects the processing system to the service provider internal network.

12. The method of claim 8, wherein the plurality of internal services comprises at least one of: a domain name system service, a parental control service, a secure browsing service, a cyber security service, or a video policy service.

13. The method of claim 7, wherein the core network interface connects the communications service provider core network to an internet.

14. The method of claim 13, wherein the destination is the internet.

15. The method of claim 7, wherein the core network interface connects the communications service provider core network to a specialized network.

16. The method of claim 15, wherein the specialized network is the destination.

17. The method of claim 15, wherein the specialized network is at least one of: a peered content provider network, a carrier hotel network, or a cloud service provider network.

18. The method of claim 7, wherein the service provider internal network is connected to at least one network outside of the communications service provider core network via the internal network interface.

19. A non-transitory computer-readable medium storing instructions which, when executed by a processing system of a device in a communications service provider core network, the processing system including at least one processor, cause the processing system to perform operations, the operations comprising:
obtaining a characteristic of a first network traffic flow received from a user endpoint device that is connected to the communications service provider core network via an access network;
determining whether the characteristic indicates a need to route the first network traffic flow over a virtual private network;
creating an encrypted tunnel from the device to a virtual private network proxy; and
routing the first network traffic flow to the virtual private network proxy via the encrypted tunnel.

20. A device comprising:
a processing system including at least one processor; and
a non-transitory computer-readable medium storing instructions which, when executed by the processing system, cause the processing system to perform operations, the operations comprising:
obtaining a characteristic of a first network traffic flow received from a user endpoint device that is connected to a communications service provider core network in which the device resides, wherein the user endpoint device is connected to the communications service provider network via an access network;
determining whether the characteristic indicates a need to route the first network traffic flow over a virtual private network;
creating an encrypted tunnel from the device to a virtual private network proxy; and
routing the first network traffic flow to the virtual private network proxy via the encrypted tunnel.
